(19) United States
(12) Patent Application Publication
(10) Pub. No.: US 2025/0384250 A1
(43) Pub. Date: Dec. 18, 2025

(54) MEMORY-EFFICIENT GENERATIVE MACHINE LEARNING MODELS WITH LONG INPUT PROMPTS

(71) Applicant: QUALCOMM Incorporated, San Diego, CA (US)

(72) Inventors: Minsoo KIM, Seoul (KR); Simyung CHANG, Suwon (KR); Kyuhong SHIM, Seoul (KR); Juntae LEE, Seoul (KR); Jihwan BANG, Seoul (KR); Seunghan YANG, Incheon (KR)

(21) Appl. No.: 19/009,175

(22) Filed: Jan. 3, 2025

Related U.S. Application Data
(60) Provisional application No. 63/659,656, filed on Jun. 13, 2024.

(51) Int. Cl. G06N 3/0475; G06N 3/0985

(52) U.S. Cl. CPC G06N 3/0475; G06N 3/0985

(57) ABSTRACT

Certain aspects of the present disclosure provide techniques and apparatus for machine learning. In an example method, a set of data is generated based on a subset of tokens, from a sequence of tokens used as an input prompt to a generative machine learning model, using an attention mechanism of the generative machine learning model. The set of data is compressed based on a respective novelty score of each respective token of the first subset of tokens in accordance with one or more memory criteria. A set of positional embeddings associated with the compressed set of data is reorganized, and an output of the generative machine learning model is generated based on the compressed set of data and the reorganized set of positional embeddings.

### CROSS-REFERENCE TO RELATED APPLICATION(S)

The present application for patent claims the benefit of and priority to U.S. Provisional Application No. 63/659,656, filed Jun. 13, 2024, which is hereby expressly incorporated by reference herein in its entirety as if fully set forth below and for all applicable purposes.

### INTRODUCTION

Aspects of the present disclosure relate to generative machine learning.

A wide variety of machine learning model architectures have been developed to perform a variety of tasks, including generation of data such as text, images, video, audio, and the like, entity classification or detection, value or probability regression, and many others. Many modern model architectures, such as transformer-based models, rely on attention operations to process input. For example, many models use self-attention to improve the accuracy and reliability of the output predictions and/or generated data. Generally, attention mechanisms have proven to be useful in a wide variety of tasks, including diffusion models, large language models (LLMs), large vision models (LVMs), large multimodal models (LMMs), and the like.

However, many models that rely on attention operations struggle to process long input sequences due to a variety of factors, including limited available memory (e.g., because longer contexts rely on correspondingly large amount of memory), computational complexity that increases quadratically with context length, as well as accuracy losses when the input length differs from the sequence length used during training.

### BRIEF SUMMARY

Certain aspects of the present disclosure provide a processor-implemented method, comprising: generating a first set of data based on a first subset of tokens, from a sequence of tokens used as an input prompt to a generative machine learning model, using an attention mechanism of the generative machine learning model; compressing the first set of data based on a respective novelty score of each respective token of the first subset of tokens in accordance with one or more memory criteria; reorganizing a set of positional embeddings associated with the compressed first set of data; and generating an output of the generative machine learning model based on the compressed first set of data and the reorganized set of positional embeddings.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for improved generative machine learning, according to some aspects of the present disclosure.

FIG. 2 depicts an example workflow for iterative cache compression in generative machine learning models, according to some aspects of the present disclosure.

FIG. 3 depicts an example workflow for cognitive contextual retention and compression in generative machine learning models, according to some aspects of the present disclosure.

FIG. 4 is a flow diagram depicting an example method for memory-efficient generative machine learning, according to some aspects of the present disclosure.

FIG. 5 is a flow diagram depicting an example method for iterative processing in generative machine learning models, according to some aspects of the present disclosure.

FIG. 6 is a flow diagram depicting an example method for improved cache compression in generative machine learning models, according to some aspects of the present disclosure.

FIG. 7 is a flow diagram depicting an example method for generative machine learning, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved generative machine learning. Specifically, in some aspects of the present disclosure, improved contextual compression can be used to more efficiently perform generative machine learning with reduced computational expense and/or improved accuracy.

In some aspects, a framework (referred to in some aspects as “InfiniPot”) may be provided to enable long (e.g., infinite) context processing, even on memory-constrained LLMs, using techniques and/or algorithms that significantly improve contextual compression (referred to in some aspects as “cyclic cache distillation” or “CCD”).

A large variety of generative machine learning models are trained on (relatively short) fixed context lengths (e.g., input prompts or sequences of a fixed maximum length). During inference, however, much longer input sequences can be frequently encountered. Some conventional models suffer precipitous accuracy reductions for such longer context lengths, due at least in part to the out-of-distribution positional embeddings (PEs) caused by the long context lengths (where the positional embeddings for some or many of the tokens in the input sequence are outside of the range on which the model was trained).

Further, some conventional approaches to reduce the computational expense of generative machine learning (and other attention-based models) have included use of caches to store some intermediate data (e.g., the keys (K) and/or values (V) of some or all of the tokens in the input sequence, referred to in some aspects as “KV caching”). Though this can reduce the obligation to repeatedly generate such values (thereby reducing computational expense), such caching can substantially increase the memory footprint of the generative process.

In some aspects of the present disclosure, chunk-based iterative compression, cognitive contextual retention, and efficient positional embedding maintenance can be used to improve generative machine learning model performance. For example, using some aspects of the present disclosure, longer input sequences (e.g., sequences which may be longer than those used during training and/or may be longer than those that can be conventionally processed using the memory resources available) can be efficiently processed to generate model output that may be more accurate with reduced computational expense.

In some aspects, as discussed in more detail below, chunk-based iterative compression can be used to prevent or reduce declines in input parallelism efficiency. For example, in some aspects, input tokens (or data generated therefrom, such as in a KV cache) can be dynamically compressed prior to reaching and/or exceeding defined memory limits (e.g., a maximum cache size). In some aspects, this dynamic compression can be performed iteratively (e.g., for each input chunk) to enable continued processing of the input sequence while keeping memory usage within the defined limitations.

In some aspects, the dynamic compression can be performed in a way to retain useful information while discarding less useful information, improving model accuracy while reducing memory footprint. For example, in some aspects, the generative model may retain information that is highly useful (referred to in some aspects as “major information,” such as based on the attention scores of the tokens, and/or information that is highly novel (referred to in some aspects as “novel information,” such as based on the token's entropy, confidence, error, and the like). In some aspects, to generate improved (e.g., more valuable or useful) attention scores within chunks of input tokens, catalyst prompts (which may be referred to in some aspects as a “CaP”) can be introduced to guide the generative process, as discussed in more detail below.

In some aspects, in addition to dynamic chunk compression, the generative models can manage positional embeddings within the range the model has been trained on (e.g., the in-distribution range) while significantly improving efficiency by avoiding frequent recalculations of positional embeddings. In some aspects, sparse incrementation of positional indices (e.g., incrementing indices sparsely until the next compression event) can be used. In some aspects, when a compression event is used, positional embeddings can be reorganized for the compressed tokens (e.g., treating the PEs as a dense sequence), maintaining or improving computational efficiency.

### Example Workflow for Improved Generative Machine Learning

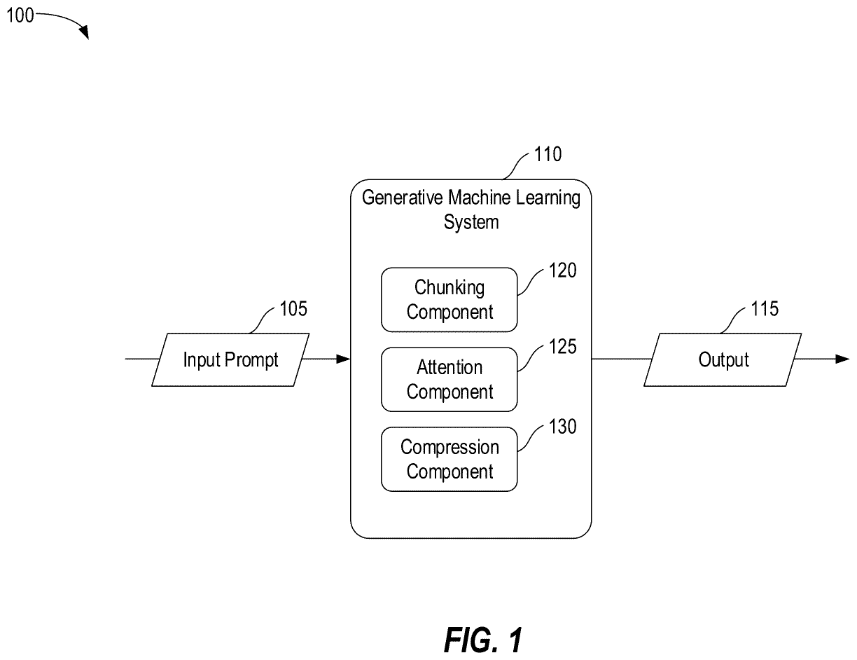

FIG. 1 depicts an example workflow 100 for improved generative machine learning, according to some aspects of the present disclosure.

In the depicted workflow 100, a generative machine learning system 110 accesses an input prompt 105 to generate an output 115. As used herein, “accessing” data may generally include receiving, requesting, retrieving, obtaining, generating, collecting, to otherwise gaining access to the data. Although depicted as a discrete computing system for conceptual clarity, in some aspects, the operations of the generative machine learning system 110 may be implemented using hardware, software, or a combination of hardware and software, and may be distributed across any number and variety of systems.

In some aspects, the input prompt 105 generally comprises an ordered sequence of elements (referred to as “tokens” in some aspects). The particular contents and format of the input prompt 105 may vary depending on the particular implementation. For example, if the generative machine learning system 110 comprises an LLM, the input prompt 105 may include natural language text (e.g., where each element or token corresponds to a character, word (or portion thereof), or phrase). In some aspects, the elements of the input prompt 105 may be “tokenized” to generate tokens using attention mechanisms, as discussed in more detail below. Similarly, the particular content and format of the output 115 may vary depending on the particular implementation. For example, the output 115 may include a natural language textual string, an image, and the like.

In some aspects, the generative machine learning system 110 may comprise or implement one or more machine learning models (e.g., generative machine learning models such as diffusion models, LLMs, LVMs, LMMs, and the like). In some aspects, as part of the machine learning model operations, the generative machine learning system 110 may perform one or more attention operations (e.g., using transformers) to process the input data. Generally, attention operations (such as self-attention operations) use learned weight tensors to project input features (e.g., the elements of the input prompt 105 or features generated therefrom) to a set of intermediate data (e.g., query (Q), key (K), and value (V) matrices). These intermediate data tensors can then be combined or evaluated to generate one or more (weighted) attention scores for each respective token (e.g., for each element of the input prompt 105) based on the data contained in the respective token and/or the data contained in one or more other tokens in the input prompt 105.

In some aspects, each token in the input prompt 105 (or features generated therefrom) attends to each other token using the attention mechanism. However, as discussed above, performing this attention using some conventional approaches can result in substantial computational overhead (e.g., quadratic compute time with respect to the number of tokens, as well as high memory usage). Although some prior attempts have been made to mitigate or reduce the computational expense of the attention process on long sequences of tokens, some conventional methods fail to adequately perform. For example, some sliding window methods (where attention for each token is computed based on a subset of tokens smaller than the entire sequence) can reduce error in long inputs, but do not effectively utilize contextual information from outside of the relatively constrained window.

In some aspects of the present disclosure, the generative machine learning system 110 can perform dynamic sequence chunking and compression to significantly improve model performance (e.g., generating improved outputs) with reduced computational expense (e.g., reduced memory footprint, reduced compute cycles, reduced power consumption, and the like).

In the illustrated example, the generative machine learning system 110 comprises a chunking component 120, an attention component 125, and a compression component 130. Although depicted as discrete components for conceptual clarity, in some aspects, the operations of the depicted components (and others not illustrated) may be combined or distributed across any number of components and systems, and each may generally be implemented using hardware, software, or a combination of hardware and software.

In some aspects, the chunking component 120 is used to delineate (e.g., divide) the input prompt 105 (or features extracted therefrom) into a set of chunks for processing. For example, if the input prompt 105 comprises a sequence of N tokens, the chunking component 120 may divide the input prompt 105 into a set of chunks, each having M or fewer tokens (where M<N). In some aspects, the chunking component 120 divides the input prompt 105 into chunks based on one or more memory criteria. For example, the chunking component 120 may divide the input prompt 105 into chunks such that each chunk can be processed within the available memory (e.g., such that the chunk and/or intermediate data generated while processing the chunk fits within a defined cache size). In some aspects, the size of each chunk may be a hyperparameter (e.g., a size defined by a data engineer or other user who trains and/or uses the machine learning model). In some aspects, the size of each chunk is defined such that the number of tokens in each chunk is equal to or less than the length of the sequences used to train the machine learning model (e.g., to prevent out-of-distribution PEs).

In some aspects, the chunking component 120 divides the input prompt 105 into chunks prior to any of the tokens being processed using the generative machine learning model. That is, the attention component 125 may generate the chunks of tokens, and each chunk may then be processed. In other aspects, the attention component 125 may divide the input prompt 105 into chunks dynamically during processing. For example, each token of the input prompt 105 may be processed sequentially until the defined criteria (e.g., a maximum number of tokens, a maximum memory or cache size, and the like) is satisfied. The attention component 125 may then delineate the set of tokens into a chunk, and a new chunk can be started by the next token in the sequence.

In the illustrated example, the attention component 125 may be used to apply attention mechanism(s) to the input prompt 105 (e.g., to each token in the sequence). In some aspects, as discussed above, the attention component 125 may use a Q, K, and V formulation (e.g., applying learned weight matrices to generate queries, keys, and/or values for each token). In some aspects, the queries, keys, and values generated during the attention operations may generally be referred to as intermediate values and/or intermediate data (or simply as “data” in some aspects). In some aspects, the attention component 125 may generate an attention score for each token in the input prompt 105 based on this intermediate data for one or more tokens.

In some aspects, to prevent (or reduce) context fragmentation between chunks and/or to improve model accuracy, catalyst prompts can be introduced during the attention operations. That is, in some aspects, the attention component 125 may process each chunk (generating attention scores for each token in the chunk) based in part on a catalyst prompt that helps improve the model output. In some aspects, the catalyst prompt(s) comprise one or more textual strings requesting information from the sequence of tokens. For example, the attention component 125 may use a catalyst prompt such as “summarize the critical points in this section” or “what is the key information here?” Generally, the catalyst prompt may relate to or inquire about information that is likely to be important or useful for the actual task corresponding to the input prompt 105.

For example, suppose the input prompt 105 comprises context (e.g., a sequence of tokens providing context for the request, such as an academic paper) and an instruction (e.g., asking the generative machine learning system 110 to explain the methodology used in the paper). Generally, regardless of the particular instruction or request included in the input prompt 105, asking the model to summarize or identify the most important parts of each chunk may be likely to return the information (from each chunk) that is most relevant for implementing the actual provided instruction. In some aspects, the catalyst prompt is a hyperparameter of the model (e.g., a fixed or predefined request) and is not based on the instruction(s) or request(s) included in the input prompt 105.

In some aspects, as discussed above, some or all of the intermediate data used to generate the attention score for each token may be stored or cached to reduce the computational expense of the generative model. For example, rather than re-computing the keys, queries, and values for each token (to generate attention with respect to one or more other tokens), the attention component 125 may cache the keys and values in a memory cache. This is referred to as key-value caching (or simply KV caching) in some aspects. While this data caching can reduce the processor time used to generate the output 115, the caching can increase the memory footprint of the model.

In the illustrated workflow 100, the compression component 130 can dynamically compress the stored intermediate data (e.g., the KV cache) for each chunk to reduce this memory footprint. For example, in some aspects, once all tokens in a given chunk (or other set of tokens) have been processed (by the attention component 125) to generate respective attention scores, the compression component 130 may then dynamically compress the intermediate data (e.g., the KV cache) of the chunk (or other set of tokens) to a smaller memory size.

In some aspects, compressing the data associated with the chunk (or other set of tokens) comprises determining, for each respective datum (e.g., for each set of intermediate data associated with a given token), whether to retain or discard the datum. For example, in some aspects, the compression component 130 may determine whether to retain or discard the respective keys and values (in the KV cache) associated with each respective token in the chunk (or other set of tokens). By retaining some intermediate data and discarding others, the compression component 130 can effectively reduce the size of the cached data, allowing the model to remain within the designated memory limits.

In some aspects, to determine whether to retain the cached data for a given token, the compression component 130 may evaluate or estimate the importance of the given token in the chunk (or other set of tokens). In some aspects, the compression component 130 seeks to retain major information, novel information, and/or both major and novel information. Generally, a “major information score” for a given token may be defined based on how important the token is predicted to be in the future (e.g., for evaluating future tokens and/or for executing the provided input instruction). In some aspects, for example, the major information of each given token may be defined as the attention score of the given token. In some aspects, for purposes of compression, the attention score (referred to as a “major information score” in some aspects) for the i-th token xᵢ may be defined as

$${\sum }_{t = i}^{t = ∞} Attn ( {x}_{t} \to {x}_{i} )$$

(e.g., the cumulative attention score of the i-th token with respect to each other token from i to infinity (or until the end of the chunk, other set of tokens, and/or input prompt 105).

In some aspects, the novelty of a given token may be defined using a “novel information score” (referred to in some aspects as a “novelty score”) indicating how novel or unique the given token is (with respect to the input prompt 105, chunk, and/or other set of tokens). Generally, a variety of formulations may be used to define the novelty score for a given token, such as the cross-entropy of the token with respect to prior tokens in the sequence (e.g., defined as −logP(xᵢ|x_{1:i-1})), where higher cross-entropy scores indicate higher novelty. As additional examples, the novelty score of the given token may be defined at least in part based on the determined output entropy of the token (where higher entropy indicates higher novelty), the confidence score of the token (where lower confidence indicates higher novelty), and/or the next token prediction error for the given token (where higher error indicates higher novelty).

Generally, the compression component 130 may use a variety of formulations to define the novelty score and the attention score for a given token. In some aspects, the compression component 130 may combine these major and novel information scores using a variety of operations and techniques to determine whether to retain or discard the data (e.g., KV) associated with a given token. For example, in some aspects, the compression component 130 may compute a weighted sum of the two metrics, or may retain the cached data based on each metric separately (e.g., retaining a given datum if either score is sufficiently high). In some aspects, the compression component 130 may use a trained machine learning model (e.g., a small neural network) that receives the novelty score and attention score as input, and generates an output importance score used to determine whether to retain each given set of data.

In some aspects, the compression component 130 compares the novelty scores, attention scores, and/or importance scores of each token in the chunk (or other set of tokens being compressed) to one or more defined (e.g., fixed) thresholds to determine whether to retain or discard each datum. In some aspects, the compression component 130 uses a dynamic threshold. For example, in some aspects, the compression component 130 uses a defined target size of the cached data. As one example, the compression component 130 may seek to compress the KV cache such that the compressed cache is half the size of the original cache for the tokens (e.g., discarding the intermediate data for half of the tokens in the chunk). In some aspects, the target compressed size of the chunk is a hyperparameter of the machine learning model.

In some aspects, in addition to compressing the intermediate data (e.g., the KV cache) of the chunks, the compression component 130 may also compress or store other data such as the PEs of the tokens in a more efficient manner. For example, in some aspects, the PEs of the tokens in the chunk are generated sequentially, such that each PE has an index corresponding to the token for which the PE was generated. In some aspects, after compressing the KV cache (e.g., removing data associated with one or more tokens from the cache), the compression component 130 may similarly discard the corresponding PEs for the tokens that were discarded. In some aspects, this may result in a relatively sparse PE data structure (e.g., with gaps between PEs corresponding to indices which were removed during compression). In some aspects, the compression component 130 may densify the PEs (e.g., reorganizing the PEs to eliminate the gaps in the indices) for the compressed tokens, allowing the generative machine learning system 110 to treat the PEs as a dense sequence (rather than a sparse sequence). This can help maintain computational efficiency, as compared to sparse PEs.

In some aspects, after compressing the current chunk, the generative machine learning system 110 can begin processing the subsequent chunk from the input prompt 105. In some aspects, processing the next chunk can be performed in part based on the prior (compressed) chunk(s). For example, when computing attention scores for tokens in a given chunk, the generative machine learning system 110 may evaluate not only the other tokens in the given chunk, but also the token(s) that were retained in prior compressed chunk(s) (e.g., using the cached KV data from prior chunks). That is, the generative machine learning system 110 may essentially create a “new” chunk that includes the tokens from the prior compressed chunk(s) and the tokens of the current chunk. This “new” chunk can then be processed for further compression. This can tie the chunk contexts together to prevent or reduce fragmentation and improve model output.

In some aspects, when a given chunk is to be processed, the generative machine learning system 110 may compress not only the given chunk (e.g., determining to retain or discard the intermediate data associated with each token in the given chunk), but may also further compress the prior compressed chunk(s). For example, suppose the cache or memory has sufficient space to store data (e.g., KV) for four thousand tokens. In some aspects, the generative machine learning system 110 may compress the first chunk from four thousand tokens to two thousand (e.g., discarding half of the tokens). If the next chunk is two thousand tokens, the generative machine learning system 110 may then compress the combination (e.g., the compressed first chunk and the uncompressed second chunk) to the same target size of two thousand tokens. This process can be repeated until all chunks have been processed without exceeding the memory limits.

In the illustrated workflow 100, when the last context chunk of the input prompt 105 is processed, the generative machine learning system 110 may use the original instruction (from the input prompt 105), rather than a catalyst prompt, to generate the attention scores. As a result, the generative machine learning system 110 may generate the output 115 responsive to the input prompt 105.

In these ways, using dynamic context chunking and compression, catalyst prompts, and/or PE reorganizations to, the generative machine learning system 110 can substantially improve the operations of generative machine learning models. For example, as discussed above, the generative machine learning system 110 may reduce memory usage of the generative process, improve the retention of important information in the reduced memory (e.g., using the contextual retention and discarding of data), improve model accuracy and reduce context fragmentation (e.g., using catalyst prompts), and retain compute efficiency (e.g., by reorganizing the PEs at compression).

### Example Workflow for Iterative Cache Compression in Generative Machine Learning Models

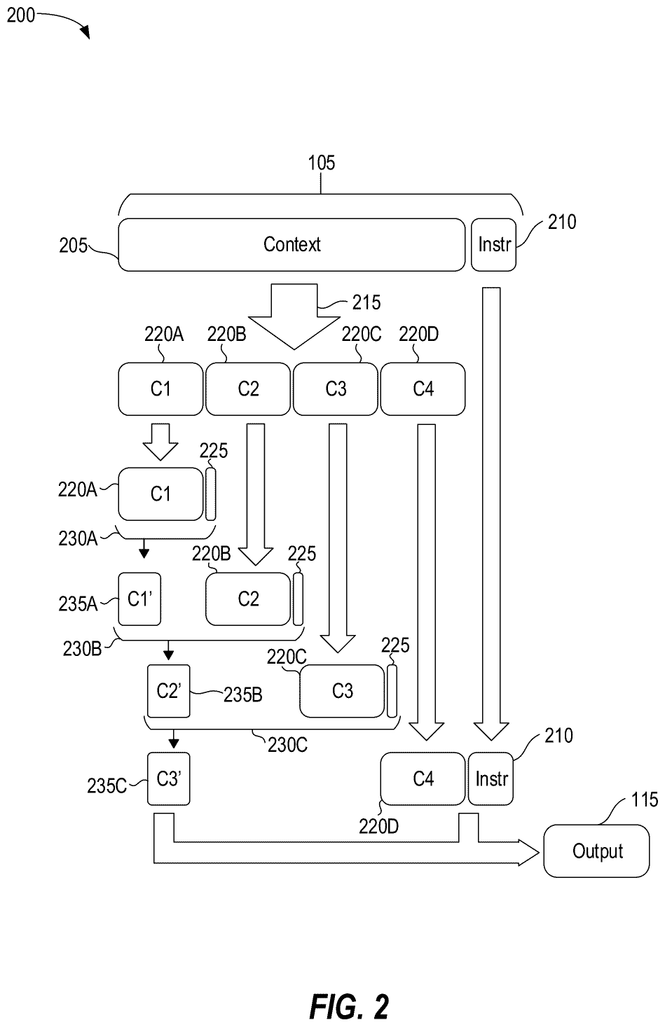

FIG. 2 depicts an example workflow 200 for iterative cache compression in generative machine learning models, according to some aspects of the present disclosure. In some aspects, the workflow 200 is performed by a generative machine learning system, such as the generative machine learning system 110 of FIG. 1.

In the illustrated example, an input prompt 105 comprising context 205 and an instruction 210 is accessed for processing using a generative machine learning model. For example, in some aspects, the instruction 210 may generally indicate the desired output (e.g., requesting information, summarization, and the like), and the context 205 may be used to provide the answer. For example, the context 205 may be the contents of a chapter of a textbook, and the instruction 210 may request that the generative machine learning system summarize the chapter, or provide more information about specific parts of the chapter.

In the illustrated workflow 200, as indicated by operation 215, the context 205 of the input prompt 105 is divided into a set of chunks 220A (labeled “C1”), 220B (labeled “C2”), 220C (labeled “C3”), and 220D (labeled “C4”) (collectively, chunks 220). Although the illustrated example depicts the use of four chunks 220, the generative machine learning system may generally use any number of chunks, as discussed above. In some aspects, the chunks 220 are generated based on the memory criteria of the model and/or system (e.g., to ensure that the KV cache is not exceeded for a given chunk). Further, although the illustrated example depicts chunks 220 of equal size for conceptual clarity, in some aspects, the chunks 220 may have varying sizes.

In the illustrated workflow 200, the first chunk 220A may be processed, along with a catalyst prompt 225, using an operation 230A to generate a compressed chunk 235A (labeled “C1′”). That is, as discussed above, the sequence of tokens in the first chunk 220A may be processed along with a catalyst prompt 225 using an attention operation (e.g., by the attention component 125 of FIG. 1) to generate attention scores for the tokens in this first chunk 220A. In some aspects, as discussed above, the generative machine learning system may additionally generate a novelty score for each token in the chunk 220A. As illustrated, the generative machine learning system can then compress the intermediate data for the chunk 220A (e.g., the KV cache for the chunk 220A and/or the PEs for the chunk 220A) to form the compressed chunk 235A (labeled “C1′” in the illustrated example). In some aspects, as discussed above, the generative machine learning system may compress the data by determining, for each token, whether to retain or discard the corresponding intermediate data based on the novelty score of the token, the attention score of the token, or a combination of the two. In some aspects, this processing of the first chunk 220A may be referred to as a first forward pass of the model.

As illustrated, once the first compressed chunk 235A has been generated, the generative machine learning system may process the second chunk 220B and the first compressed chunk 235A, along with the catalyst prompt 225, using the operation 230B to generate a second compressed chunk 235B (labeled “C2”). In the illustrated example, in addition to the tokens in the chunk 220B, the generative machine learning system may also process the (retained) tokens from the compressed chunk 235A during this second pass. That is, the attention scores and other data for the tokens in the second chunk 220B may be determined based at least in part on other tokens in the chunk 220B as well as the tokens corresponding to the compressed chunk 235A. For example, the tokens corresponding to the compressed chunk 235A and the tokens corresponding to the chunk 220B may be treated as a single sequence of tokens (e.g., a single “chunk”) when performing the initial processing of the second chunk 220B.

In some aspects, as discussed above, when compressing the second chunk 220B (and the compressed chunk 235A) to form the compressed chunk 235B, the generative machine learning system may further compress the compressed chunk 235A (e.g., potentially discarding tokens from the compressed chunk 235A that were retained when compressing the first chunk 220A). For example, as discussed above, the generative machine learning system may compress both the compressed chunk 235A and the chunk 220B to ensure that the number of retained tokens (e.g., the size of the KV cache) in the resulting compressed chunk 235B remains equal to or less than the target memory criteria.

As illustrated, once the second compressed chunk 235B has been generated, the generative machine learning system may process the third chunk 220C and the second compressed chunk 235B, along with the catalyst prompt 225, using the operation 230C to generate a third compressed chunk 235C (labeled “C3′”). In the illustrated example, in addition to the tokens in the chunk 220C, the generative machine learning system may also process the (retained) tokens from the previous compressed chunks 235A and 235B during this third pass (reflected in the compressed chunk 235C). That is, the attention scores and other data for the tokens in the third chunk 220C may be determined based at least in part on other tokens in the chunk 220C as well as the tokens corresponding in the compressed chunk 235B (which incorporates any retained tokens from the compressed chunk 235A, as discussed above). For example, the tokens retained during prior compression of the chunks 220A and 220B (reflected in the compressed chunk 235B) and the tokens corresponding to the chunk 220C may be treated as a single sequence of tokens when processing the third chunk 220C.

In some aspects, when compressing the third chunk 220C (and the compressed chunk 235B) to form the compressed chunk 235C, the generative machine learning system may further compress the compressed chunks 235A and/or 235B, as discussed above. For example, as discussed above, the generative machine learning system may further compress the compressed chunk 235B (e.g., potentially discarding tokens from the chunks 220A and 220B that were retained during the prior compression operations) as well as the chunk 220B to ensure that the number of retained tokens (e.g., the size of the KV cache) remains equal to or less than the target memory criteria.

In the illustrated workflow 200, once the third compressed chunk 235C has been generated, the generative machine learning system may then process the fourth (and final) chunk 220D and the compressed chunk 235C, along with the instruction 210 from the input prompt 105, to generate the output 115. As illustrated, in addition to the tokens in the chunk 220D, the generative machine learning system may also process the (retained) tokens from the compressed chunks 235A, 235B, and 235C during this fourth and final pass. That is, the attention scores and other data for the tokens in the fourth chunk 220D, as well as the final output 115 of the model, may be determined based at least in part on other tokens in the chunk 220D as well as the tokens corresponding retained in the compressed chunk 235C, as discussed above. For example, the tokens corresponding to the compressed chunk 235C (which inherently incorporate the contributions of the chunks 220A, 220B, and 220C, as discussed above) and the tokens corresponding to the chunk 220D may be treated as a single sequence of tokens when processing the instruction 210 to generate the model output 115.

In the illustrated example, the generative machine learning system uses the actual instruction 210 when performing this final pass to ensure that the output 115 aligns with the original request in the input prompt 105. That is, while catalyst prompts 225 can be useful to guide the attention operations for the intermediate chunks 220 (which may not otherwise have any knowledge or awareness of the ultimate goal of the processing), once all tokens in the context 205 have been processed (or are currently being processed, such as the tokens in the final chunk 220D), the generative machine learning system can use the instruction 210 to generate correct output 115.

In some aspects, as discussed above, the catalyst prompts 255 may be hyperparameters of the model and may have no relation to the actual instruction 210. For example, the catalyst prompt 255 may state “summarize this section” while the actual instruction 210 may be entirely unrelated, such as “how frequently does this text include synonyms for ‘good’ as compared to synonyms for ‘bad’?” Nevertheless, the use of such catalyst prompts 255 can prevent or reduce context fragmentation and improve the resulting output 115 substantially in some implementations.

### Example Workflow for Cognitive Contextual Retention and Compression in Generative Machine Learning Models

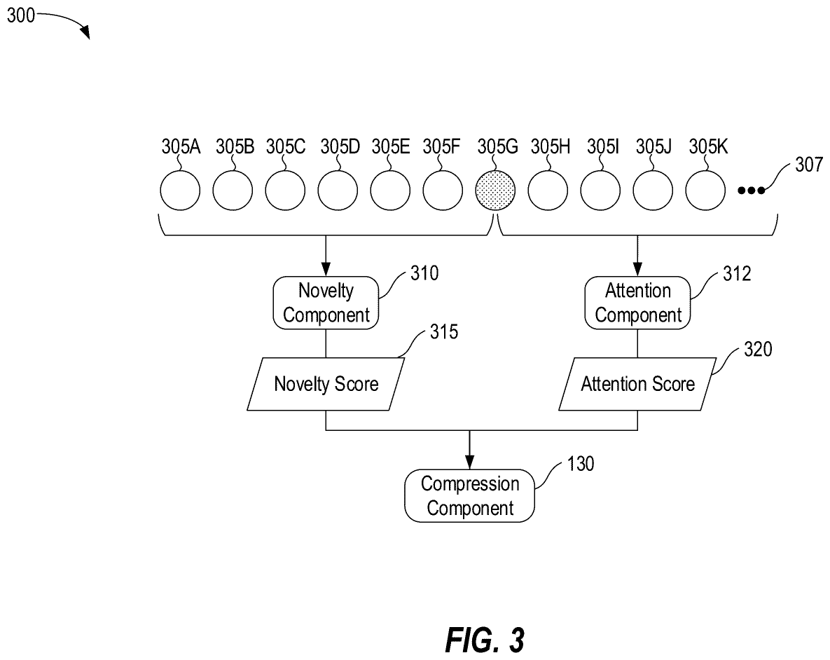

FIG. 3 depicts an example workflow 300 for cognitive contextual retention and compression in generative machine learning models, according to some aspects of the present disclosure. In some aspects, the workflow 300 may be performed by a generative machine learning system, such as the generative machine learning system 110 of FIG. 1 and/or the generative machine learning system discussed above with reference to FIG. 2. In some aspects, the workflow 300 provides additional detail for the compression operations discussed above (e.g., for the compression component 130 of FIG. 1).

The illustrated example includes a sequence of tokens 305A-K (collectively, tokens 305). As indicated by the ellipses 307, the sequence of tokens 305 may be of any length. In the workflow 300, the generative machine learning system is determining whether to retain or discard the token 305G (indicated by stippling) when compressing the chunk to which the token 305G corresponds. That is, the generative machine learning system is determining whether to retain intermediate data associated with the token 305G, such as the keys and/or values (e.g., in a KV cache) and/or positional embedding for the token 305G. In some aspects, as discussed above, the generative machine learning system determines whether to retain the data for each given token 305 based on the (predicted) importance of the given token 305, which may be determined based on the novelty of the given token 305 (e.g., indicated by the novelty score 315) and/or the future value of the given token 305 (e.g., indicated by the attention score 320).

In the illustrated example, a novelty component 310 (which may be a component of the compression component 130) may evaluate a set of one or more tokens 305 prior to (and, in some cases, including) the given token 305G to generate the novelty score 315. Specifically, in the workflow 300, the novelty component 310 evaluates the tokens 305A, 305B, 305C, 305D, 305E, 305F, and 305G. Generally, the novelty score 315 indicates how novel the given token 305G is, based on the token(s) 305A-F that the generative machine learning system has already evaluated in the chunk (or other set of tokens, such as in the entire input prompt, if tokens from prior compressed chunks are also evaluated). That is, each of the tokens 305A-F may be included in the same chunk as the token 305G, or may correspond to tokens from a compressed chunk (e.g., from one or more prior chunks), where the tokens 305A-F were retained during the prior compression operations.

For example, as discussed above, the novelty score 315 may be defined based on the output entropy of the token 305G, the confidence score of the model with respect to the token 305G, the next prediction error of the token 305G, the cross-entropy of the token 305G, and the like. In the illustrated example, this novelty score 315 is evaluated by the compression component 130 to compress the chunk.

Similarly, in the illustrated example, an attention component 312 (which may be a component of the compression component 130, or may correspond to the attention component 125 of FIG. 1) may evaluate a set of one or more tokens 305 subsequent to (and, in some cases, including) the given token 305G to generate the attention score 320.

Specifically, in the workflow 300, the attention component 312 evaluates the tokens 305G, 305H, 3051, 305J, 305K, and so on. Generally, the attention score 320 indicates how valuable or important the given token 305G is with respect to future tokens, based on the token(s) 305A-K that follow the token 305G in the given chunk (or other set of tokens).

In some aspects, as discussed above, the attention score 320 may be defined based in part on a catalyst prompt (e.g., the catalyst prompt 225 of FIG. 2) to improve the predictive value of the attention score 320. In the illustrated example, this attention score 320 is evaluated by the compression component 130 to compress the chunk.

As discussed above, the compression component 130 may generally perform a variety of operations to determine whether to retain or discard a given token (and the corresponding intermediate data, such as the KV cache, PEs, and the like) based on the novelty score 315 and/or attention score 320. For example, in some aspects, the compression component 130 may determine whether a weighted or unweighted sum of the novelty score 315 and the attention score 320 meet or exceed a criteria (e.g., placing the token 305G in the top half of the tokens 305 that have so far been retained). Generally, any suitable criteria may be used to evaluate the novelty score 315 and/or attention score 320.

As discussed above, based on these scores, the compression component 130 can dynamically compress the set of tokens by discarding token(s) 305 that do not satisfy the criteria and retaining tokens 305 that do. This can reduce memory usage of the model while retaining important information to assist the generation process, as discussed above.

### Example Method for Memory-Efficient Generative Machine Learning

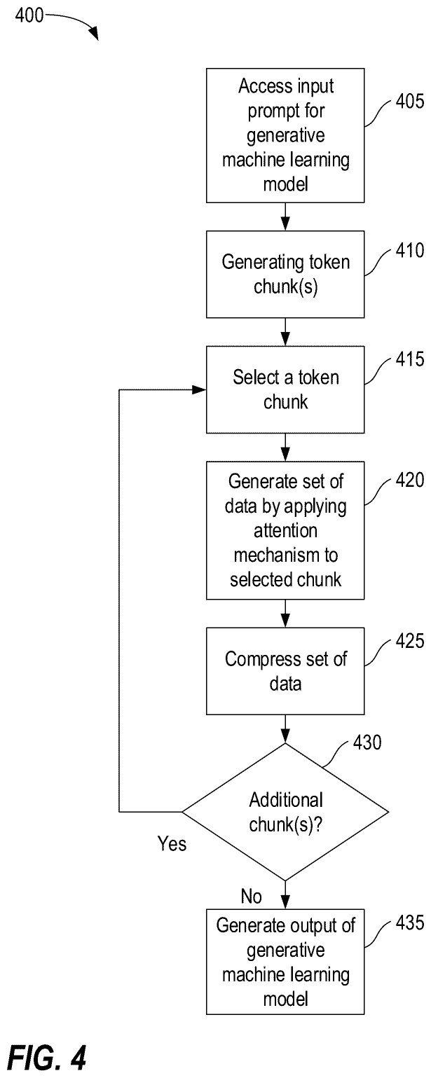

FIG. 4 is a flow diagram depicting an example method 400 for memory-efficient generative machine learning, according to some aspects of the present disclosure. In some aspects, the method 400 is performed by a generative machine learning system, such as the generative machine learning system 110 of FIG. 1 and/or the generative machine learning system discussed above with reference to FIGS. 2-3.

At block 405, the generative machine learning system accesses an input prompt (e.g., the input prompt 105 of FIG. 1) for a generative machine learning model. In some aspects, as discussed above, the input prompt may comprise an instruction or request (e.g., the instruction 210 of FIG. 2) and/or contextual data (e.g., the context 205 of FIG. 2). Generally, as discussed above, the input prompt comprises a sequence of tokens or other elements (e.g., words, phrases, characters, and the like).

At block 410, the generative machine learning system generates a set of token chunks (e.g., the chunks 220 of FIG. 2). In some aspects, as discussed above, the generative machine learning system generates the token chunks in accordance with one or more memory criteria (e.g., to ensure that the set of tokens included in each chunk, or the intermediate data that will be generated based on the tokens in each chunk, does not exceed a defined memory limit, such as the available memory cache).

At block 415, the generative machine learning system selects a token chunk. In some aspects, the generative machine learning system may select the token chunk using a variety of techniques or operations, as each chunk of tokens will be processed during the method 400. In some aspects, the generative machine learning system selects the chunks sequentially (e.g., beginning with the first chunk and proceeding to the final chunk).

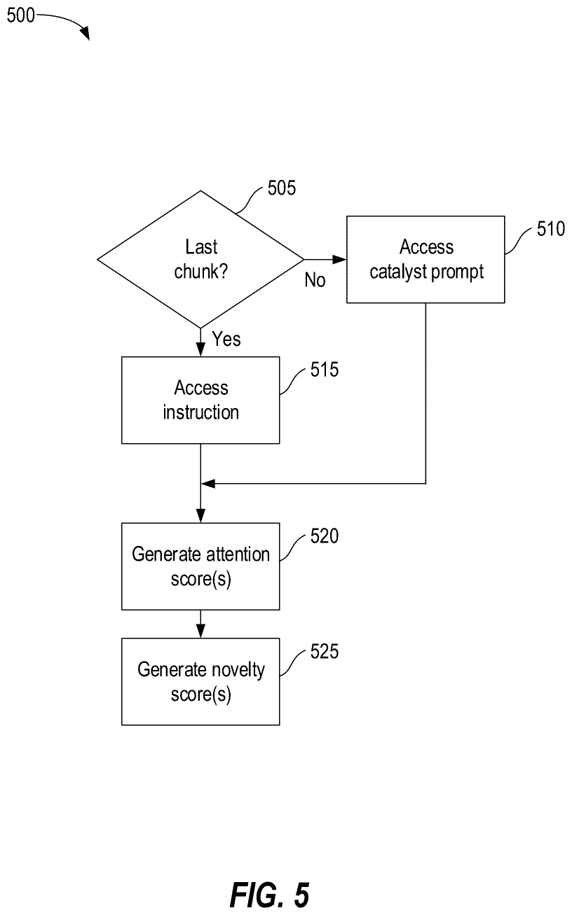

At block 420, the generative machine learning system generates a set of data by applying an attention mechanism to the selected chunk. As discussed above, this “set of data” may generally include intermediate data (e.g., keys, values, and/or queries for each token in the chunk), PEs for each token, attention scores for each token, novelty scores for each token, and the like. In some aspects, as discussed above, the generative machine learning system may generate the set of data based on applying the attention mechanism to a sequence of tokens including any tokens that were retained from prior compressed chunks and the tokens from the currently selected chunk. In some aspects, the method 500 of FIG. 5 provides additional detail for block 420.

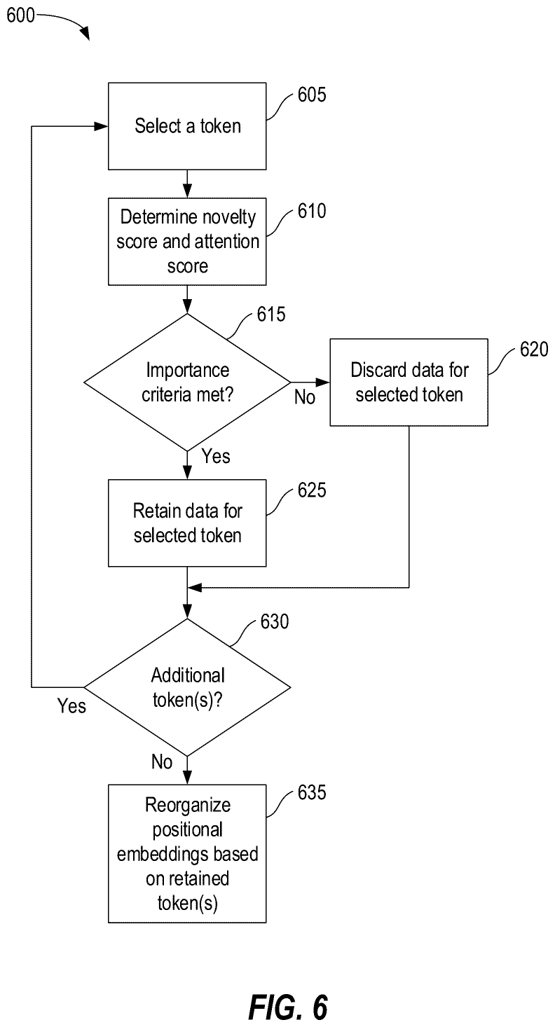

At block 425, the generative machine learning system compresses the set of data (generated at block 420) for the chunk. In some aspects, at block 425, the generative machine learning system also compresses the set of data generated for any retained tokens from any prior chunks, as discussed above. In some aspects, as discussed above, the generative machine learning system compresses the set of data (also referred to in some aspects as compressing the chunk) based on determining whether to retain or discard each respective token in the current set of tokens (e.g., the tokens in the currently selected chunk, as well as the token(s) retrained form prior chunk(s) during prior compression operations). In some aspects, for example, the generative machine learning system may evaluate the attention score of each token, the novelty score of each token, and the like. In some aspects, as discussed above, compressing the set of data may include compressing one or more other sets of data (e.g., for prior chunk(s)) as well. In some aspects, the method 600 of FIG. 6 provides additional detail for block 425.

At block 430, the generative machine learning system determines whether there is at least one additional chunk remaining, from the input prompt, to be processed. If so, the method 400 returns to block 415. If not, the method 400 continues to block 435, where the generative machine learning system generates the output (e.g., the output 115 of FIG. 1) of the generative model. In some aspects, at block 430, the generative machine learning system determines whether at least two chunks remain. For example, as discussed above, if two or more chunks remain, the method 400 may return to block 415 to continue ingesting and compressing tokens. If a single chunk remains, the method 400 may continue to block 435 to generate the model output using the (compressed) chunk(s) and the final (uncompressed) chunk. For example, as discussed above, the generative machine learning system may evaluate the tokens that were retained from each compressed chunk, along with the tokens in the final chunk and the instruction (included in the prompt) to generate the output.

### Example Method for Iterative Processing in Generative Machine Learning Models

FIG. 5 is a flow diagram depicting an example method 500 for iterative processing in generative machine learning models, according to some aspects of the present disclosure. In some aspects, the method 500 is performed by a generative machine learning system, such as the generative machine learning system 110 of FIG. 1 and/or the generative machine learning system discussed above with reference to FIGS. 2-4. In some aspects, the method 500 provides additional detail for block 420 of FIG. 4.

At block 505, the generative machine learning system determines whether the current chunk (e.g., the chunk of tokens that is currently being processed) is the last or final contextual chunk in the sequence of chunks, a reflected in the input prompt. If not, the method 500 continues to block 510, where the generative machine learning system accesses a catalyst prompt (e.g., the catalyst prompt 255 of FIG. 2) to process the current chunk. In some aspects, as discussed above, the catalyst prompt may be a hyperparameter instruction (e.g., unrelated to any user input) generically requesting information related to or from the context (e.g., asking the model to summarize the context). The method 500 then continues to block 520.

Returning to block 505, if the generative machine learning system determines that the current chunk is the final chunk in the sequence, the method 500 continues to block 515. At block 515, the generative machine learning system accesses the instruction (e.g., the instruction 210 of FIG. 2) that was included in the input prompt. The method 500 then continues to block 520.

At block 520, the generative machine learning system generates an attention score for each token in the current set of tokens (e.g., the tokens in the current chunk, as well as any tokens retained from prior chunks) based on the accessed instruction (e.g., either the catalyst prompt or the prompt instruction). In some aspects, as discussed above, the generative machine learning system may generate the attention score for each given token based on the token itself, one or more other tokens in the chunk, and/or one or more tokens from prior chunks (e.g., the tokens that were retained when prior chunks were compressed). In some aspects, as discussed above, generating the attention score for a given token may include computing the keys (K), queries (Q), and/or values (V) for the token based on learned matrices. In some aspects, as discussed above, some or all of these intermediate data (e.g., the keys and values) may be cached for prior tokens (e.g., in a KV cache) to substantially reduce the computational expense (e.g., to prevent re-generating the data) of the model.

At block 525, the generative machine learning system generates a novelty score for each token in the current set of tokens (e.g., the tokens in the current chunk and the token(s) retained from any prior chunks). In some aspects, as discussed above, the novelty score may be determined based on factors such as the entropy of the token, the confidence of the model's prediction for the token, the error in the next token prediction for the token, and the like.

### Example Method for Improved Cache Compression in Generative Machine Learning Models

FIG. 6 is a flow diagram depicting an example method 600 for improved cache compression in generative machine learning models, according to some aspects of the present disclosure. In some aspects, the method 600 is performed by a generative machine learning system, such as the generative machine learning system 110 of FIG. 1 and/or the generative machine learning system discussed above with reference to FIGS. 2-5. In some aspects, the method 600 provides additional detail for block 425 of FIG. 4.

At block 605, the generative machine learning system selects a token. In some aspects, the generative machine learning system may select the token using any suitable criteria, including randomly or pseudo-randomly, as all relevant tokens will be evaluated during the method 600. In some aspects, at block 605, the generative machine learning system selects a token from the current chunk (e.g., the chunk that is being compressed). In some aspects, the generative machine learning system may select the token from the current chunk or from a prior (compressed) chunk. That is, as discussed above, the generative machine learning system may re-evaluate tokens from prior (compressed) chunks when compressing the current chunk, allowing the generative machine learning system to ensure that the resulting compressed data (for all chunks processed thus far) remain within the defined memory criteria. Stated differently, to compress a current chunk, the generative machine learning system may merge or aggregate the current chunk with the retained token(s) from the prior chunk(s) in the sequence, allowing the generative machine learning system to generate a single new compressed chunk that incorporates the contributions of each prior chunk or token.

At block 610, the generative machine learning system determines the novelty score and/or the attention score for the selected token (e.g., generated using the method 500 of FIG. 5).

At block 615, the generative machine learning system determines whether the novelty score and/or attention score of the selected token satisfies one or more importance criteria. For example, in some aspects, the generative machine learning system may determine whether the score(s) meet or exceed a threshold. In some aspects, rather than using a fixed threshold, the generative machine learning system may determine whether either or both score(s) are in a top percentile (e.g., the top 50%) of the tokens in the set of retained tokens. Generally, the generative machine learning system may use any suitable criteria and operations to evaluate the scores. For example, as discussed above, the generative machine learning system may sum or average the scores, process the score using a machine learning model, and the like.

If, at block 615, the generative machine learning system determines that the importance criteria are not met, the method 600 continues to block 620, where the generative machine learning system discards the data for the selected token. For example, as discussed above, the generative machine learning system may discard (e.g., delete, refrain from maintaining, or otherwise refrain from further storage or use of) the data. In some aspects, as discussed above, the discarded data may include the intermediate data (e.g., the keys and values for the token in the KV cache), the attention score of the token, the novelty score of the token, the PE of the token, the token itself, and the like. The method 600 then continues to block 630.

Returning to block 615, if the generative machine learning system determines that the importance criteria are met, the method 600 continues to block 625, where the generative machine learning system retains the data for the selected token. For example, as discussed above, the generative machine learning system may retain (e.g., store, cache, maintain, or otherwise keep and/or use) the data. In some aspects, as discussed above, the retained data may include the intermediate data (e.g., the keys and values for the token in the KV cache), the attention score of the token, the novelty score of the token, the PE of the token, the token itself, and the like. The method 600 then continues to block 630.

At block 630, the generative machine learning system determines whether there is at least one token remaining to be processed. If so, the method 600 returns to block 605. Although the generative machine learning system depicts an iterative process (selecting and evaluating each token in sequence) for conceptual clarity, in some aspects, the generative machine learning system may evaluate some or all of the tokens in parallel.

If no further tokens remain, the method 600 continues to block 635, where the generative machine learning system reorganizes the PEs of the retained tokens, as discussed above. For example, the generative machine learning system may compress or densify the PEs of the retained tokens to a dense set of indices (e.g., indices without gaps), such as by mapping or remapping the indices of the retained PEs to a continuous memory block in the cache (rather than leaving memory gaps between the retained PEs). In some aspects, this reorganization can be implemented using any suitable transformation or mapping function that ensures the positional embeddings remain within the distribution learned during training. This can improve or maintain compute complexity of the model.

### Example Method for Generative Machine Learning

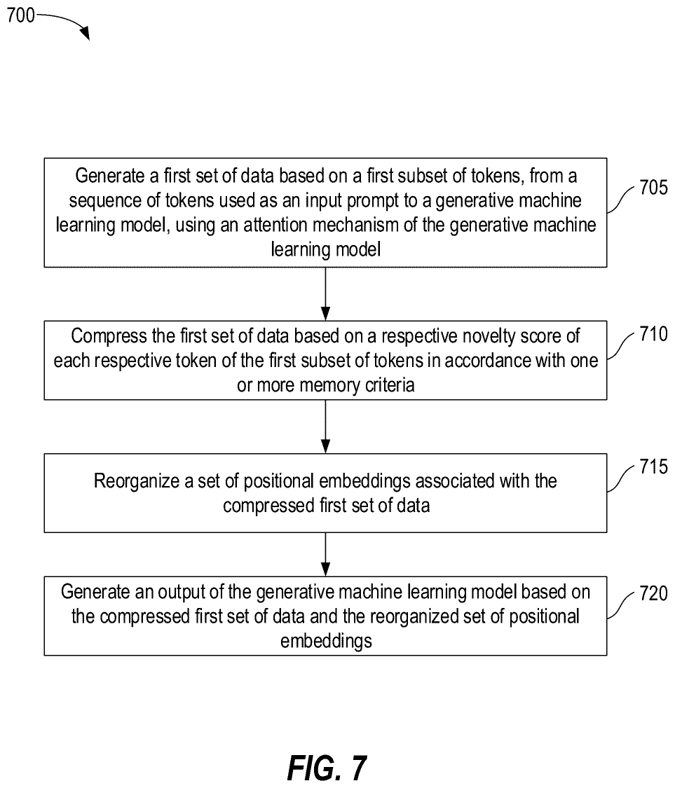

FIG. 7 is a flow diagram depicting an example method 700 for generative machine learning, according to some aspects of the present disclosure. In some aspects, the method 700 is performed by a generative machine learning system, such as the generative machine learning system 110 of FIG. 1 and/or the generative machine learning system discussed above with reference to FIGS. 2-6.

At block 705, a first set of data is generated based on a first subset of tokens, from a sequence of tokens used as an input prompt to a generative machine learning model, using an attention mechanism of the generative machine learning model.

At block 710, the first set of data is compressed based on a respective novelty score of each respective token of the first subset of tokens in accordance with one or more memory criteria.

At block 715, a set of positional embeddings associated with the compressed first set of data is reorganized.

At block 720, an output of the generative machine learning model is generated based on the compressed first set of data and the reorganized set of positional embeddings.

In some aspects, the method 700 further includes generating a second set of data based on a second subset of tokens from the sequence of tokens and compressing the second set of data in accordance with the one or more memory criteria.

In some aspects, the method 700 further includes further compressing the first set of data based on the second set of data and the one or more memory criteria.

In some aspects, the first set of data comprises a set of keys and a set of values generated for the first subset of tokens using the attention mechanism of the generative machine learning model.

In some aspects, compressing the first set of data comprises determining, for each respective datum of the first set of data, whether to retain the respective datum based at least in part on the respective novelty score of a corresponding token.

In some aspects, the respective novelty score of each respective token is generated based on at least one of: (i) a respective output entropy of the respective token, (ii) a respective confidence score of the respective token, or (iii) a respective next token prediction error of the respective token.

In some aspects, compressing the first set of data further comprises determining, for each respective datum of the first set of data, whether to retain the respective datum based further on a respective attention score of a corresponding token.

In some aspects, the respective attention score of each respective token is generated based on processing the respective token using a catalyst prompt.

In some aspects, the catalyst prompt comprises a textual string requesting information from the sequence of tokens.

In some aspects, the catalyst prompt is a hyperparameter of the generative machine learning model.

In some aspects, reorganizing the set of positional embeddings comprises remapping the set of positional embeddings to a set of indices corresponding to the compressed first set of data.

### Example Processing System for Generative Machine Learning

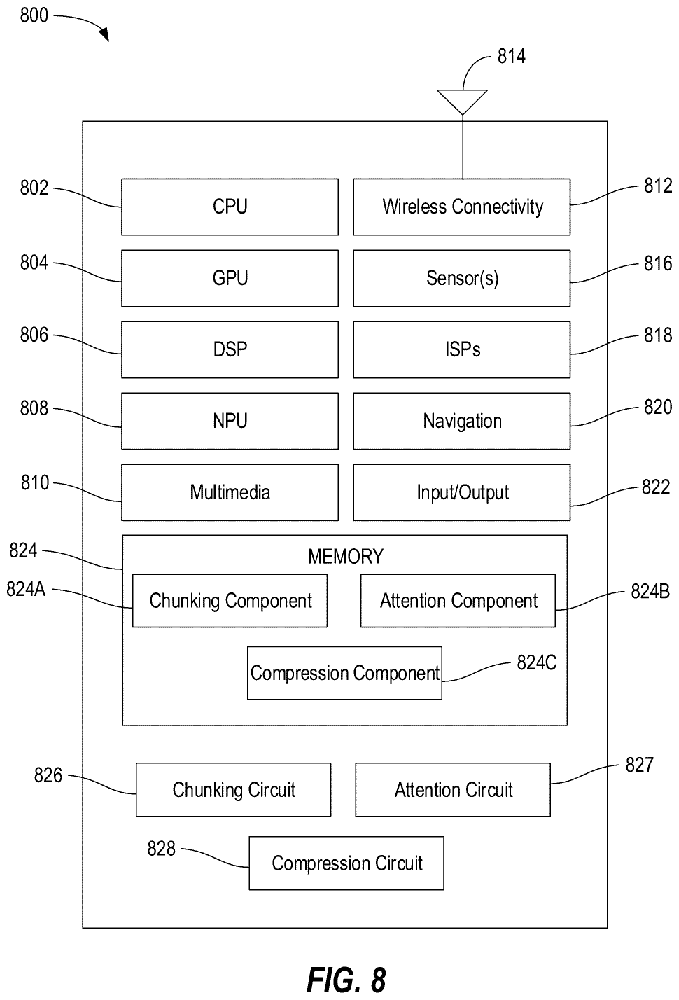

FIG. 8 depicts an example processing system 800 configured to perform various aspects of the present disclosure, including, for example, the techniques and methods described with respect to FIGS. 1-7. In some aspects, the processing system 800 may correspond to a generative machine learning system. For example, the processing system 800 may correspond to the generative machine learning system 110 of FIG. 1, and/or the generative machine learning system discussed above with reference to FIGS. 2-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a chunking component 824A, an attention component 824B, and a compression component 824C. Although not depicted in the illustrated example, the memory 824 may also include other components, such as an inferencing or generation component to manage the generation of output data using generative machine learning models, a training component used to train or update the generative machine learning model(s), and the like. Though depicted as discrete components for conceptual clarity in FIG. 8, the illustrated components (and others not depicted) may be collectively or individually implemented in various aspects.

Further, although not depicted in the illustrated example, the memory 824 may also include various data, such as a set of model parameters (e.g., parameters of one or more generative machine learning models), training data, and the like.

The processing system 800 further comprises a chunking circuit 826, an attention circuit 827, and a compression circuit 828. The depicted circuits, and others not depicted (such as an inferencing circuit), may be configured to perform various aspects of the techniques described herein.

The chunking component 824A and/or the chunking circuit 826 (which may correspond to the chunking component 120 of FIG. 1) may be used to generate chunks of tokens (e.g., the chunks 220 of FIG. 2), as discussed above. For example, the chunking component 824A and/or the chunking circuit 826 may divide the input prompts (e.g., input prompt 105 of FIG. 1) into chunks in accordance with one or more defined memory criteria (e.g., a maximum preferred memory or cache size).

The attention component 824B and/or the attention circuit 827 (which may correspond to the attention component 125 of FIG. 1) may be used to apply attention operations or mechanisms to tokens, as discussed above. For example, the attention component 824B and/or the attention circuit 827 may generate attention scores for each token in a given chunk based on one or more other tokens in the same chunk and/or in a different chunk, as discussed above.

The compression component 824C and/or the compression circuit 828 (which may correspond to the compression component 130 of FIG. 1) may be used to dynamically compress chunks of tokens during runtime, as discussed above. For example, the compression component 824C and/or the compression circuit 828 may determine whether to retain or discard each token (and the accompanying intermediate data) in accordance with the one or more memory criteria based on the perceived or predicted importance of each token (e.g., based on the novelty score and/or attention score), as discussed above.

Though depicted as separate components and circuits for clarity in FIG. 8, the chunking circuit 826, the attention circuit 827, and the compression circuit 828 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 maybe distributed between multiple devices.

### Example Clauses

Implementation examples are described in the following numbered clauses:

Clause 1: A method, comprising: generating a first set of data based on a first subset of tokens, from a sequence of tokens used as an input prompt to a generative machine learning model, using an attention mechanism of the generative machine learning model; compressing the first set of data based on a respective novelty score of each respective token of the first subset of tokens in accordance with one or more memory criteria; reorganizing a set of positional embeddings associated with the compressed first set of data; and generating an output of the generative machine learning model based on the compressed first set of data and the reorganized set of positional embeddings.

Clause 2: A method according to Clause 1, further comprising: generating a second set of data based on a second subset of tokens from the sequence of tokens; and compressing the second set of data in accordance with the one or more memory criteria.

Clause 3: A method according to Clause 2, further comprising further compressing the first set of data based on the second set of data and the one or more memory criteria.

Clause 4: A method according to any of Clauses 1-3, wherein the first set of

data comprises a set of keys and a set of values generated for the first subset of tokens using the attention mechanism of the generative machine learning model.

Clause 5: A method according to any of Clauses 1-4, wherein compressing the first set of data comprises determining, for each respective datum of the first set of data, whether to retain the respective datum based at least in part on the respective novelty score of a corresponding token.

Clause 6: A method according to any of Clauses 1-5, wherein the respective novelty score of each respective token is generated based on at least one of: (i) a respective output entropy of the respective token, (ii) a respective confidence score of the respective token, or (iii) a respective next token prediction error of the respective token.

Clause 7: A method according to any of Clauses 5-6, wherein compressing the first set of data further comprises determining, for each respective datum of the first set of data, whether to retain the respective datum based further on a respective attention score of a corresponding token.

Clause 8: A method according to Clause 7, wherein the respective attention score of each respective token is generated based on processing the respective token using a catalyst prompt.

Clause 9: A method according to Clause 8, wherein the catalyst prompt comprises a textual string requesting information from the sequence of tokens.

Clause 10: A method according to any of Clauses 8-9, wherein the catalyst prompt is a hyperparameter of the generative machine learning model.

Clause 11: A method according to any of Clauses 1-10, wherein reorganizing the set of positional embeddings comprises remapping the set of positional embeddings to a set of indices corresponding to the compressed first set of data.

Clause 12: A processing system comprising: a memory comprising processor-executable instructions; and one or more processors coupled to the one or more memories and configured to execute the processor-executable instructions and cause the processing system to perform a method in accordance with any of Clauses 1-11.

Clause 13: A processing system comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
generate a first set of data based on a first subset of tokens, from a sequence of tokens used as an input prompt to a generative machine learning model, using an attention mechanism of the generative machine learning model;
compress the first set of data based on a respective novelty score of each respective token of the first subset of tokens in accordance with one or more memory criteria;
reorganize a set of positional embeddings associated with the compressed first set of data; and
generate an output of the generative machine learning model based on the compressed first set of data and the reorganized set of positional embeddings.

2. The processing system of claim 1, wherein the one or more processors are configured to execute the processor-executable instructions and further cause the processing system to:
generate a second set of data based on a second subset of tokens from the sequence of tokens; and
compress the second set of data in accordance with the one or more memory criteria.

3. The processing system of claim 2, wherein the one or more processors are configured to execute the processor-executable instructions and further cause the processing system to further compress the compressed first set of data based on the second set of data and the one or more memory criteria.

4. The processing system of claim 1, wherein the first set of data comprises a set of keys and a set of values generated for the first subset of tokens using the attention mechanism of the generative machine learning model.

5. The processing system of claim 1, wherein the respective novelty score of each respective token is generated based on at least one of: (i) a respective output entropy of the respective token, (ii) a respective confidence score of the respective token, or (iii) a respective next token prediction error of the respective token.

6. The processing system of claim 1, wherein, to compress the first set of data, the one or more processors are configured to execute the processor-executable instructions and cause the processing system to determine, for each respective datum of the first set of data, whether to retain the respective datum based at least in part on the respective novelty score of a corresponding token.

7. The processing system of claim 6, wherein, to compress the first set of data, the one or more processors are configured to execute the processor-executable instructions and further cause the processing system to determine, for each respective datum of the first set of data, whether to retain the respective datum based further on a respective attention score of a corresponding token.

8. The processing system of claim 7, wherein the respective attention score of each respective token is generated based on processing the respective token using a catalyst prompt.

9. The processing system of claim 8, wherein the catalyst prompt comprises a textual string requesting information from the sequence of tokens.

10. The processing system of claim 8, wherein the catalyst prompt is a hyperparameter of the generative machine learning model.

11. The processing system of claim 1, wherein, to reorganize the set of positional embeddings, the one or more processors are configured to execute the processor-executable instructions and cause the processing system to remap the set of positional embeddings to a set of indices corresponding to the compressed first set of data.

12. A processor-implemented method of machine learning, comprising:
generating a first set of data based on a first subset of tokens, from a sequence of tokens used as an input prompt to a generative machine learning model, using an attention mechanism of the generative machine learning model;
compressing the first set of data based on a respective novelty score of each respective token of the first subset of tokens in accordance with one or more memory criteria;
reorganizing a set of positional embeddings associated with the compressed first set of data; and
generating an output of the generative machine learning model based on the compressed first set of data and the reorganized set of positional embeddings.

13. The processor-implemented method of claim 12, further comprising:
generating a second set of data based on a second subset of tokens from the sequence of tokens; and
compressing the second set of data in accordance with the one or more memory criteria.

14. The processor-implemented method of claim 13, further comprising further compressing the compressed first set of data based on the second set of data and the one or more memory criteria.

15. The processor-implemented method of claim 12, wherein the first set of data comprises a set of keys and a set of values generated for the first subset of tokens using the attention mechanism of the generative machine learning model.

16. The processor-implemented method of claim 12, wherein the respective novelty score of each respective token is generated based on at least one of: (i) a respective output entropy of the respective token, (ii) a respective confidence score of the respective token, or (iii) a respective next token prediction error of the respective token.

17. The processor-implemented method of claim 12, wherein compressing the first set of data comprises determining, for each respective datum of the first set of data, whether to retain the respective datum based at least in part on the respective novelty score of a corresponding token.

18. The processor-implemented method of claim 17, wherein compressing the first set of data further comprises determining, for each respective datum of the first set of data, whether to retain the respective datum based further on a respective attention score of a corresponding token.

19. The processor-implemented method of claim 18, wherein:
the respective attention score of each respective token is generated based on processing the respective token using a catalyst prompt,
the catalyst prompt comprises a textual string requesting information from the sequence of tokens, and
the catalyst prompt is a hyperparameter of the generative machine learning model.

20. The processor-implemented method of claim 12, wherein reorganizing the set of positional embeddings comprises remapping the set of positional embeddings to a set of indices corresponding to the compressed first set of data.
